(19) United States
(12) Patent Application Publication
(10) Pub. No.: US 2008/0154717 A1
(43) Pub. Date: Jun. 26, 2008

(54) Publisher scoring

(75) Inventors: Qasim Saifee, West Hills, CA (US); Steve Dang, Los Angeles, CA (US); Brian Dolan, Los Angeles, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/644,127

(22) Filed: Dec. 22, 2006

(51) Int. Cl. G06Q 30/00

(52) U.S. Cl. 705/14

(57) ABSTRACT

A system and method are disclosed for a publisher scoring algorithm. Various factors or variables are analyzed for publishers to determine a score associated with the publishers. The score may be a reflection of the success or value a publisher provides to an advertisement provider or an advertiser.

### BACKGROUND

Online advertising may be an important source of revenue for an enterprise engaged in electronic commerce. A number of different kinds of web page-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain a location for inclusion of an advertisement. An advertisement can be selected for display each time the page is requested, for example, by a browser or server application.

Various web sites may utilize a third party to provide advertisements to be displayed on their web pages. The revenues generated by those advertisements may then be split between the third party, also referred to as an advertising provider, and the website owner. The website owner may be referred to as a publisher, who is publishing a website or displaying a product that includes advertisements. The advertisement provider may evaluate those publishers for which it provides advertisements. The evaluations or ratings of the publishers may reflect a variety of factors and be used to ensure that publishers are following the rules and upholding the image of the advertisement provider. Accordingly, it would be beneficial to have a thorough and comprehensive way to analyze the publishers in this regard.

### BRIEF DESCRIPTION OF THE DRAWINGS

The system may be better understood with reference to the following drawings and description. Non-limiting and non-exhaustive embodiments are described with reference to the following drawings. The components in the figures are not necessarily to scale, emphasis instead being placed upon illustrating the principles of the invention. In the figures, like referenced numerals designate corresponding parts throughout the different views.

FIG. 1 is a diagram of one embodiment of a system for providing advertising;

FIG. 2 is a diagram of an alternate embodiment of an advertising system;

FIG. 3 is a diagram of one embodiment of exemplary publisher scoring;

FIG. 4 is a chart depicting an embodiment of a transformation function;

FIG. 5 is a flowchart depicting an embodiment of a publisher scoring algorithm;

FIG. 6 is an illustration of an exemplary published page having advertisements displayed thereon; and

FIG. 7 is an illustration a general computer system.

### DETAILED DESCRIPTION

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims and be defined by the following claims. Nothing in this section should be taken as a limitation on those claims. Further aspects and advantages are discussed below in conjunction with the embodiments.

The principles and aspects described herein may be embodied in many different forms. By way of introduction, the embodiments described below include a system and method for analyzing one or more publishers of advertisements provided by an advertisement provider. The publishers display content, which includes one or more advertisements provided by the advertisement provider on behalf of an advertiser which may be the advertisement provider or another entity. In particular, the embodiments relate to an algorithm for analyzing, ranking, and/or scoring the publishers. The advertisement provider and/or advertiser may have guidelines or rules for utilizing its advertisements and the scoring may reflect the degree to which the publishers follow or adhere to these guidelines. The guidelines may be established to ensure the provided advertisements are associated with non-offensive content and the provided advertisements may be tracked to ensure that they are displayed in a compliant manner and meet quality requirements. In addition, the ranking may reflect which providers are the most profitable in terms of consumers clicking on or viewing the sites associated with the advertisements, referred to as “click-thru.” In another aspect, the ranking may be a reflection of the quality of a publisher to an advertiser or advertisement provider. Quality, in turn, may indicate the value that advertisers and/or advertisement providers assign to a publisher. Accordingly, advertisers may only want the advertising provider to place its advertisements with publishers of a certain quality. The overall score of a publisher may include a quality value for each publisher.

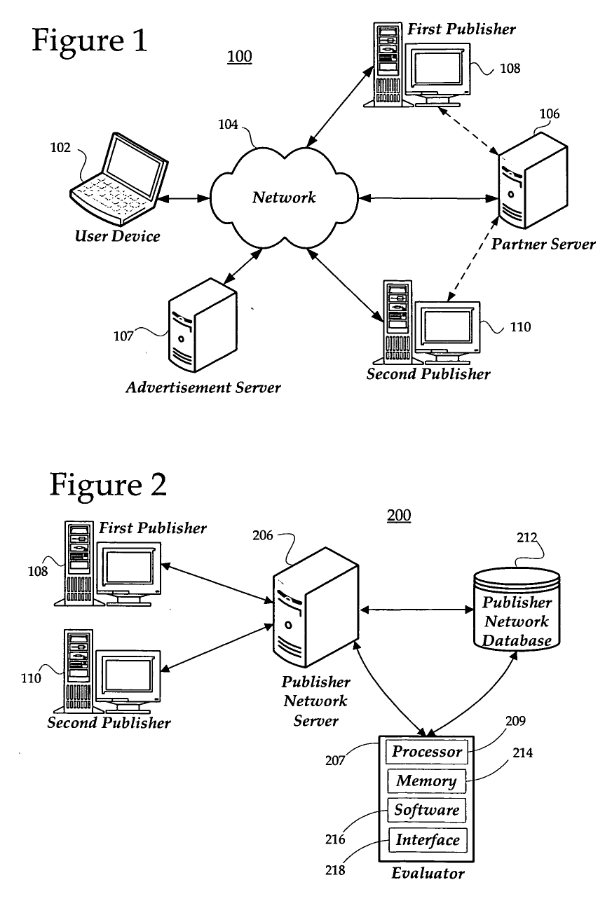

FIG. 1 is a diagram of one embodiment of a system 100 for providing advertising. The system 100 includes a user device 102 coupled with a network 104. An advertisement server 107, partner server 106, first publisher 108 and second publisher 110 are also coupled with the network 104. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be any device that a user utilizes to connect with the network 104. In one embodiment, the network 104 is the Internet and the user device 102 connects with a website provided by a web server coupled with the network 104. In alternate embodiments, there may be multiple user devices 102 representing the users that are connected with the network 104. A user may not only include any individual, but a business entity or group of people. Any user may utilize a user device 102, which may include a conventional personal computer, a mobile user device, including a network-enabled mobile phone, VoIP phone, cellular phone, personal digital assistant (PDA), pager, network-enabled television, digital video recorder, such as TIVO®, and/or automobile. A user device 102 configured to connect with the network 104, may be the general computer system or any of the components as described in FIG. 7. In alternate embodiments, there may be additional user devices 102, and additional intermediary networks (not shown) that are established to connect the users or user devices.

The network 104 may generally be enabled to employ any form of machine-comprehensible media for communicating information from one device to another and may include any communication method by which information may travel between devices. The network may be a network 726 as described in FIG. 7. For example, the network 104 may include one or more of a wireless network, a wired network, a local area network (LAN), a wide area network (WAN), a direct connection such as through a Universal Serial Bus (USB) port, and the like, and may include the set of interconnected networks that make up the Internet. The wireless network may be a cellular telephone network, a network operating according to a standardized protocol such as IEEE 802.11, 802.16, 802.20, published by the Institute of Electrical and Electronics Engineers, Inc., or WiMax network. Further, the network 104 may be a public network, such as the Internet, a private network, such as an intranet, or combinations thereof, and may utilize a variety of networking protocols now available or later developed including, but not limited to TCP/IP based networking protocols. Any of the components in system 100 may be coupled with one another through other networks in addition to network 104.

In one embodiment, the first publisher 108 and the second publisher 110 are content providers. The publishers 108, 110 operate one or more web servers or otherwise use web servers to provide content, such as a web site, web pages, etc., via the network 104. Accordingly, a publisher 108, 110 owns, operates or uses one or more web servers to provide the publisher's content. Alternatively, the first publisher 108 and the second publisher 110 may represent web servers or web providers. Throughout this disclosure the publishers 108, 110 may be described as being and/or including one or more web servers.

The first publisher 108 and the second publisher 110 may comprise a general computer system or any of the components as described below in FIG. 7. In one embodiment, the first publisher 108 provides a first website and the second publisher 110 provides a second website. Accordingly, the user device 102 connects with the first publisher 108 through the network 104 for access to the first website. Likewise, the user device 102 connects with the second publisher 110 through the network 104 for access to the second website. There may be many more publishers that the user device 102 may be coupled with. Each publisher may represent a different website or web domain. In alternate embodiments, the publishers may provide content that is not considered a website.

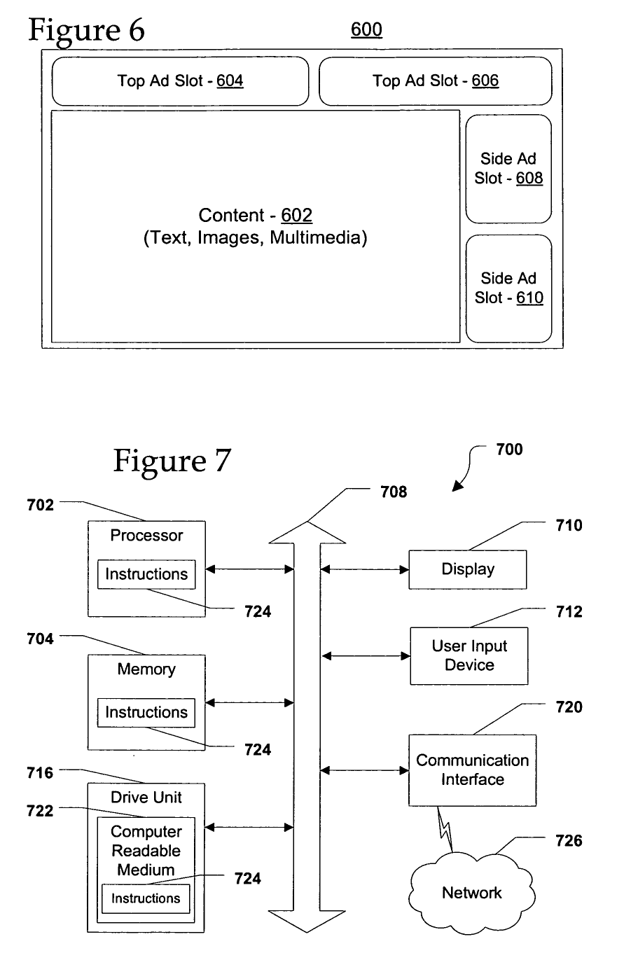

The first and second publishers 108, 110 may display advertisements on their websites that are from an advertisement provider, such as the advertisement server 107. In one embodiment, the advertisement provider utilizes the advertisement server 107 to provide advertisements to the publishers 108, 110. The advertisement provider is a content provider, where the content is advertisements, and the advertisement server 107 may be the mechanism for providing that content. Accordingly, the advertisement provider and advertisement server 107 may be referred to interchangeably. The advertisements may be transmitted to the publishers 108, 110 over the network 104 by the advertisement server 107. The advertisement server 107 may comprise a general computer system or any of the components as described below in FIG. 7. As discussed above, the advertisement server 107 may be a component of the advertisement provider. The advertisement server 107 may receive a request from one of the publishers 108, 110 to provide an advertisement for its published page to be displayed on the user device 102. An exemplary published page having advertisements displayed thereon is shown in FIG. 6, as discussed below.

The advertisement server 107 provides appropriate advertisements based on the request from the publishers. In one embodiment, the publishers 108, 110 request any advertisement for their page(s); alternatively, the publishers may be able to select the advertisements that are displayed. In one embodiment, the advertisement server 107 uses Yahoo! Content Match®, provided by Yahoo Corporation, located in California, to select advertisements to be provided to a publisher 108, 110 based on the content of the pages provided by that publisher 108, 110. Alternatively, the advertisements may be selected based on other factors or conditions, such as information about the user and the user device 102. Regardless of how the advertisements are selected, the advertisement provider provides the selected advertisements to the first and second publishers 108, 110 through the advertisement server 107. In one embodiment, the advertisements may be contained in data files that are transmitted to the publishers. The data files of the advertisements may include text, images, animations, music, video, or other information which is provided to the publishers, which then provide or display to consumers.

In one embodiment, the partner server 106 may be coupled with the publishers, such as the first publisher 108 and the second publisher 110. The partner server 106 may monitor and track those publishers that utilize the advertisement provider and/or the advertisement server 107 for advertisements displayed on the publisher's pages. In one embodiment, the partner server 106 may use a beacon stored with the publishers 108, 110 to determine the number of impressions of a page. The partner server 106 may be an intermediary between the advertisement server 107 and the publishers 108, 110. In one embodiment, the publishers are coupled with the partner server 106 directly, or through network 104. In alternate embodiments, the partner server 106 may be a part of the advertisement server 107. The partner server 106 may monitor the publishers 108, 110 and request advertisements from the advertisement server 107 for the publishers 108, 110. The partner server 106 may comprise a general computer system or any of the components as described below in FIG. 7.

FIG. 2 is a diagram of an alternate embodiment of a system 200 for providing advertising. The first publisher 108 and the second publisher 110 are coupled with a publisher network server 206. The publisher network server 206 is coupled with a publisher network database 212 and an evaluator 207. The evaluator 207 may include a processor, memory 214, software 216, and an interface 218. Variations in the arrangement and type of the components may be made without departing from the spirit or scope of the claims as set forth herein. Additional, different or fewer components may be provided.

The publisher network server 206 may be web server that is coupled with a plurality of publishers. The publisher network server 206 may be the same as or similar to the partner server 106 in system 100. The publisher network server 206 is coupled with a publisher network database 212. The publisher network database 212 includes stored data or information related to the publishers that are coupled with the publisher network server 206.

The publisher network database 212 may store data and information regarding the first and second publishers 108, 110. The stored information may relate to the specific pages or websites for each publisher 108, 110 including the content of their websites, which may be used to determine the advertisements to display. The stored information may further include the available advertisements that are available to be selected and provided to the publishers. In addition, the stored information may include data that is recorded or observed from each publisher 108, 110. For example, the success of an advertisement on a publisher's page may be monitored, including whether the advertisement resulted in a sale of a good or service. As described below, click-through-rate (CTR), revenue-per-thousand (RPM), price-per-click (PPC), and conversion rate are all examples of publisher data that may be stored in the publisher network database 212 and may be used to monitor the success of an advertisement.

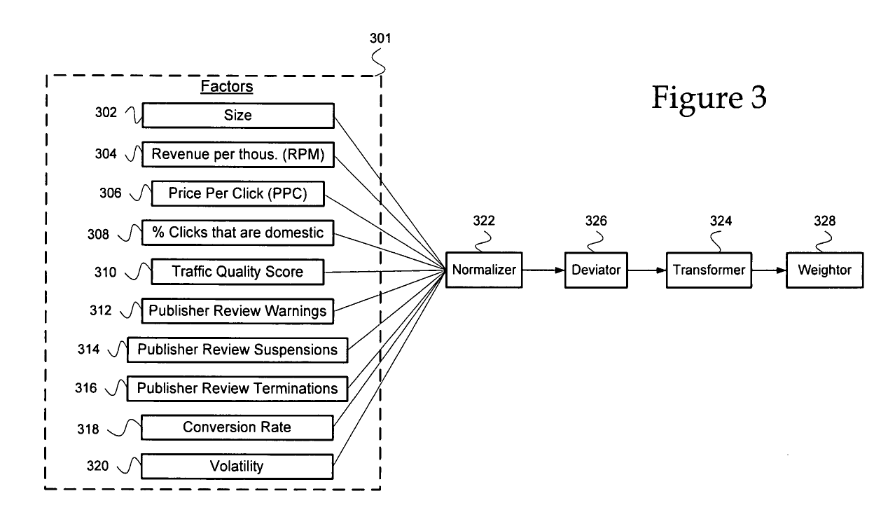

The evaluator 207 may receive data or information regarding the publishers, such as the first publisher 108 and/or the second publisher 110, and evaluate or score the publishers based on that data or information. The scoring of publishers may also be referred to as evaluating, ranking, and/or analyzing. The evaluator 207 includes a processor 209 that is configured to perform the scoring operation, described in more detail below with reference to FIG. 3, and may include a central processing unit (CPU), a graphics processing unit (GPU), digital signal processor (DSP) or other type of processing device. The processor 209 may be a component in a variety of systems. For example, the processor 209 may be part of a standard personal computer or a workstation. The processor 209 may be one or more general processors, digital signal processors, application specific integrated circuits, field programmable gate arrays, servers, networks, digital circuits, analog circuits, combinations thereof, or other now known or later developed devices for analyzing and processing data. The processor 209 may operate in conjunction with a software program, such as code generated manually (i.e., programmed).

The processor 209 may include a memory 214, or the memory 214 may be a separate component. The interface 218 and/or software 216 may be stored in memory 214. The interface 218 may allow for the evaluator to be coupled with or communicate with the publisher network server 206 and/or the publisher network database 212. Alternatively, the interface 218 may be a user interface or user input configured to allow a user to interact with any of the components of the evaluator 207, or access the publisher network database 212 or the publisher network server 206. The interface 218 may be implemented in software 216. The software 216 or the data/information that is received from the publisher network database 212 may be stored in the memory 214.

The memory 214 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 214 includes a random access memory for the processor. In alternative embodiments, the memory 214 is separate from the processor 209, such as a cache memory of a processor, the system memory, or other memory. The memory 214 may be an external storage device or database for storing recorded image data. Examples include a hard drive, compact disc (“CD”), digital video disc (“DVD”), memory card, memory stick, floppy disc, universal serial bus (“USB”) memory device, or any other device operative to store image data.

The memory 214 is operable to store instructions, such as software 216, executable by the processor. The functions, acts or tasks illustrated in the figures or described herein may be performed by the programmed processor executing the instructions stored in the memory 214. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like. In one embodiment, the software 216 may be stored in memory 214. The processor 209 is configured to execute the software 216.

Any of the components in system 200 may be coupled with one another through a network. For example, the evaluator 207 may be coupled with the publisher network server 206, publisher network database 212, advertisement server 107 (not shown in FIG. 2), and/or the partner server 106 via a network, such as network 104. Accordingly, any of the components in system 200 may include communication ports configured to connect with a network. Accordingly, the present disclosure contemplates a computer-readable medium that includes instructions or receives and executes instructions responsive to a propagated signal, so that a device connected to a network can communicate voice, video, audio, images or any other data over a network. The instructions may be transmitted or received over the network via a communication port that may be a part of a processor or may be a separate component. The communication port may be created in software or may be a physical connection in hardware. The communication port may be configured to connect with a network, external media, display, or any other components in system 200, or combinations thereof. The connection with the network may be a physical connection, such as a wired Ethernet connection or may be established wirelessly as discussed below. Likewise, the additional connections with other components of the system 200 may be physical connections or may be established wirelessly.

The interface 218 may be a user input or a display. The interface 218 may include a keyboard, keypad or a cursor control device, such as a mouse, or a joystick, touch screen display, remote control or any other device operative to interact with the evaluator 207. The interface 218 may include a display coupled with the processor and configured to display an output from the processor. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor, or specifically as an interface with the software 216, which may be stored in the memory 214.

FIG. 3 is a chart of one embodiment of an exemplary scoring process. In one embodiment, FIG. 3 may be implemented with the evaluator 207 from FIG. 2. The evaluator 207 may be used to score individual publishers based on a variety of factors 301. The relevant factors 301 may be analyzed and combined to develop a score used to evaluate and rank publishers. The factors 301 will be described individually below and may be referred to generally as publisher data/information or variables.

The size 302 of a publisher may be a factor 301 for scoring publishers. The size 302 is a reflection of the traffic on a publisher's site and may be expressed in absolute terms or relative to other publishers or another metric. In one embodiment, the size 302 may be the number of clicks on advertisements from the site. A smaller publisher site will receive fewer clicks on advertisements than a larger publisher. In alternative embodiments, the size of a publisher may be a measure of the page views, gross revenue, number of employees, or other variables that may be reflective of the number of clicks that are likely to be received on advertisements. The size 302 may be significant because a larger publisher's deficiencies may be more exaggerated than a small publisher because un-acceptable content may be viewed more often on a large publisher than a small publisher. Likewise, in terms of quality, advertisers will find a high quality large publisher a valuable resource, however, smaller high-quality publishers may not provide as much exposure. For example, a publisher with only 100 billed clicks should not receive an overall publisher score equivalent to a publisher with 10,000 billed clicks, all other factors 301 being equal. Although both publishers may be of equal quality, the publisher with 10,000 billed clicks has a much more dramatic impact on the overall network and should receive heightened scrutiny relative to the smaller publisher. In one embodiment, the size 302 may magnify or shrink the overall score of publishers. Accordingly, the size 302 may be a multiplier of the overall score.

The revenue per thousand (RPM) 304 may be a factor for scoring publishers. The RPM 304 represents the revenue that is generated per thousand impressions. An impression may be defined as a view from a consumer of an advertisement. Alternatively, RPM 304 may reflect the number of times that a consumer clicking on an advertisement results in generated revenue. In another embodiment, RPM 304 may be the revenue generated for each click or selection by a consumer divided by every thousand times that an advertisement is displayed to a consumer. In yet another embodiment, click through rate (CTR) may be the measure that is used instead of RPM. CTR is the number of times an advertisement is clicked or selected divided by the number of times that it is viewed (clicks/impressions). The larger the RPM 304, the more valuable the publisher is likely to be, which results in a higher score.

The price-per-click (PPC) 306 may be a factor 301 for scoring publishers. PPC 306 is the price that is paid for each click or selection of an advertisement. For example, each time a consumer clicks on an advertisement, the advertiser pays a predetermined price that goes to the advertisement provider and/or to the publisher of the site. In one embodiment, the advertisements may be displayed based on a bidding process in which the advertisers place a bid for the PPC 306 that they will pay for particular locations of advertisements. Accordingly, the PPC 306 may be a reflection of the value of particular locations of advertisements. A publisher with a low PPC 306 may be evidence of variety and increased depth in the offers that are advertised and may be rewarded. Accordingly, a low PPC 306 increases the diversity of the network and may be rewarded. Publishers that only display certain high PPC 306 advertisements may not be as valuable. In other words, because of the bidding process and advertisers' desire for higher click levels, high volume placements may have a higher PPC 306 than lower volume placements. Accordingly, it is conceivable that low volume placements receive a lower PPC 306, all other factors being equal. However, because low volume placements increase the diversity and depth of offers displayed on the network, a low PPC 306 may be rewarded.

The percentage of clicks that are domestic (domestic %) 308 may be a factor 301 for scoring publishers. The domestic % 308 reflects the percentage of clicks that are from domestic consumers. For example, for a U.S. website, the domestic % 308 is the percentage of clicks from consumers that are located in the U.S. Because U.S. advertisements that are not viewed by U.S. consumers are generally not as effective for resulting in conversions and/or for establishing brand recognition, another potential objective for the advertisements, the higher the domestic % 308, then the more valuable the advertisements are. The domestic % may be based on smaller areas than a country, such as a state or city. Historical data has suggested that domestic clicks convert at a higher rate relative to international clicks.

The traffic quality score (TQS) 310 may be a factor 301 for scoring publishers. The TQS 310 may be a representation of the quality of the traffic that is either viewing the publisher's page or viewing and/or clicking on the advertisements. Filters may be used to ensure that clicks are valid. An example of an invalid click would be a click generated by a publisher clicking on an advertisement on his own site in an attempt to fraudulently generate revenue based on those clicks. The TQS 310 is a reflection of those clicks that are deemed to be valid. In one embodiment, the TQS 310 is a Loss Prevention Analytics (LPA) score. The LPA score is from 1 to 5 where 1 represents when many clicks are discarded for being invalid. Clicks that are discarded are not billable to advertisers and the publisher and/or advertisement provider receive no revenue from non-billable clicks.

The publisher review warnings 312, publisher review suspensions 314, and/or publisher review terminations 316 may be factors 301 for scoring publishers. Publishers may be periodically reviewed either manually or automatically. For example, a manual review of various publishers may take place once a month. The reviews may result in additional information regarding the publisher. The review may determine whether the publisher failed to follow particular guidelines from the advertisement provider. Examples of guidelines would be forbidding objectionable content, such as pornography, or hate speech. In addition, lack of content may also be objected to, so that a publisher does not have a page that is only advertisements with no content. Accordingly, failure to follow certain guidelines may result in a warning, suspension, or termination of the publisher, which are each associated with the publisher review warnings 312, publisher review suspensions 314, and publisher review terminations 316 factors, respectively. In one embodiment, a particular publisher may include multiple pages or multiple domains. If one of the domains from the publisher is terminated, but the other domains remain active, then the terminated domain may affect the score of that publisher.

The conversion rate 318 may be a factor 301 for scoring publishers. The conversion rate 301 relates to the number of clicks on advertisements that result in some form of a desired result. In one embodiment, the desired result may be a sale of a good and/or service. Accordingly, a conversion may be a sale generated after a click on an advertisement. The conversion rate 318 may be the ratio of conversions per advertisement clicks or impressions. In one embodiment, there may be a benchmark conversion rate that is compiled over a variety of publishers and an individual publisher's conversion rate is that from the publisher divided by the benchmark. Accordingly, if the benchmark conversion rate is 10% and first publisher 108 has a conversion rate of 5%, then its conversion rate is 5% divided by 10% or 50% of the benchmark.

The volatility 320 may be a factor 301 for scoring publishers. Volatility 320 relates to the predictability of the volume of impressions or clicks a publisher delivers. The volatility may reflect the consumers' responses to the advertisements for that publisher. Increased volatility results in less predictability for advertisers and reduces the value of the advertisements for that publisher. In other words, advertisers do not like volatility and prefer to know with reasonable certainty how many impressions or clicks will be generated based on its advertisement. In one embodiment, the volatility 320 for a publisher is the standard deviation in the number of clicks per day for that publisher divided by the average number of clicks per day for that publisher. Alternatively, the volatility 320 may be calculated based on time periods other than a day.

The factors 301 that are described above may be used to generate a score for a particular publisher. The score may be calculated with any number of the factors described above or with other factors. The score may provide a way to compare publishers through individual scores for each publisher as described below. Each factor 301 that is used in the calculation may be subject to operations from a normalizer 322, deviator 326, transformer 324, and/or a weightor 328. In particular, each factor data is normalized, and then the standard deviation of the mean is transformed and a weight is applied to get a score. For each factor, the score is combined to determine a composite score that covers each factor for a publisher and may be referred to as a publisher score. The factors 301 may be subject to one of more of these operations and may also be subject to additional operations. The operations may be performed in any order in alternate embodiments.

The normalizer 322 may adjust the factors 301 to a predetermined standard. A smoothing function may be used so that the distribution of each factor 301 across publishers will approximate a normal distribution. In one example a natural log function may be used to normalize the data for each factor 301.

The deviator 326 may calculate a standard deviation from the mean for the factors 301 for each publisher. In one embodiment, the normalized data from each factor 301 is used to determine a standard deviation from the mean for each factor 301. The standard deviation from the mean may then be used to determine a raw score for each factor 301.

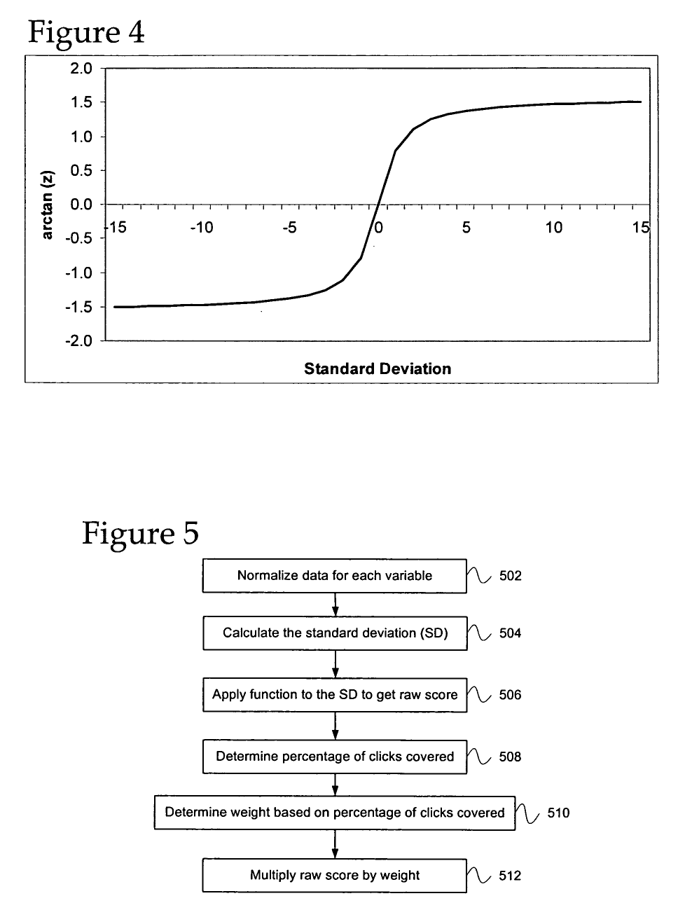

The transformer 324 may transform the score for each of the factors 301. In one embodiment, the transformation may be a normalization as in the normalizer 322. Alternatively, the standard deviation from the mean (SD) for each factor 301 for each publisher may be transformed based on a predetermined function or formula. In one embodiment, a function may be applied to the standard deviations of the normalization for the factors 301 to develop a raw score for each publisher for each factor 301. In one example the raw scoring function may be the arctangent as shown in FIG. 4. The arctangent function transforms the normalized standard deviation into a number between −1.5 and +1.5 that may be multiplied by the weight to derive the score.

The weightor 328 may include a weight for each of the factors 301. The weight associated with each factor 301 determines the value of each of the factors 301 in the final score for a publisher. Those factors 301 that are most relevant to the publisher score will be associated with the higher rate. For example, the conversion rate 318 or RPM 304 may be among the most important factors for rating publishers, so those factors may have the greatest weight. The weight for each of the factors 301 may be adjusted based on a percentage of clicks covered by the conversion counter. As the percentage of clicks covered increases, the weight associated with the conversion rate increases and the weights associated with other factors 301, such as percent domestic 308 and/or traffic quality score 310, may decline. Conversions may only be tracked if an advertiser has enabled conversion counter on their site. As a result, not all clicks on an advertisement on a publisher's site may be tracked for a conversion and the conversion rate that we calculate may only be for that subset of advertisers who enable tracking of their conversions through the conversion counter. Percentage clicks covered refer to the percentage of advertisements that are tracked. Accordingly, a publisher with a higher percentage of their clicks covered by conversion counter results in a higher confidence in the calculated conversion rate and it may be given higher weight.

Accordingly, in one embodiment, the weightor 328 may apply weights according to the following table:

| % Clicks | | | | | | |
|---|---|---|---|---|---|---|
| Covered in | Conversion | | Traffic | | | |
| Conversion Rate | Rate | % Domestic | Quality | Volatility | RPM | PPC |
| Calculation | Weight | Weight | Weight | Weight | Weight | Weight |
| 0% | 0 | 35 | 35 | 10 | 10 | 10 |
| 5% | 17.5 | 26.25 | 26.25 | 10 | 10 | 10 |
| 10% | 35 | 17.5 | 17.5 | 10 | 10 | 10 |
| 20% | 70 | 0 | 0 | 10 | 10 | 10 |
| 40% | 70 | 0 | 0 | 10 | 10 | 10 |

As described above, as the percentage of clicks covered in the conversion rate calculation increases, the conversion rate weight may also increase. Likewise, as the percentage of clicks covered in the conversion rate calculation increases, the % domestic weight and traffic quality weight may decrease. In this example, at 20% clicks covered, 70% of the score is derived from the conversion rate. Conversion rate is a good measure of advertiser performance and 20% clicks covered is the level where it is given a much higher weight used as a measure of traffic quality (70% of the overall publisher score) instead of incorporating the % domestic and the traffic quality. As shown above, Volatility, RPM, and PPC receive 10% of the weight. This is merely one embodiment of the weights that may be used to derive a publisher score. Alternate embodiments may utilize different weights at different percentages of clicks covered.

FIG. 5 illustrates a flow chart of the analysis of factors. FIG. 5 represents a formula for the calculation of a publisher score, which may be calculated as in FIG. 3. In block 502, the data for each variable or factor 301 is normalized by the normalizer 322. In block 504, the normalized data for each factor 301 is then used to calculate the standard deviation from the mean (SD) from the deviator 326. In block 506, a function is applied to the SD's for each factor 301 in the transformer 324. The function may be the arctangent as in FIG. 4, or may be a different transformation function. In block 508, the percentage of clicks covered in the conversion rate calculation is calculated. In block 510, a weight is selected for each factor 301 based on the percentage of clicks covered in the conversion rate calculation. Finally, in block 512, the weight is applied to the transformed data from the weightor 328 for each of the factors 301.

Accordingly, publisher or advertisement data is received for each publisher. The publisher or advertisement data may include any of the factors 301. In one embodiment, each of the factors 301 may have a raw score that is calculated based on the data received. The raw scores for each factor 301 may then be analyzed and processed to determine a publisher score. In one embodiment, for each factor 301, the value may be normalized, and then the standard deviation from the mean may be transformed and weighted to give a score for each factor 301. All the scores for each of the included factors 301 may then be compiled, combined, and/or averaged to give a final publisher score.

In one embodiment the equation that may be used to generate a publisher score may be: Publisher Score=f(Transformed Size SD)*(RPM weight*f(Transformed RPM SD, Transformed Conversion Rate SD)+PPC weight*f(Transformed PPC SD)+% Domestic Clicks weight*f(Transformed % Domestic Clicks SD)+Traffic Quality Score weight*f(Transformed Traffic Quality Score SD)+Volatility weight*f(Transformed Volatility SD)+Conversion Rate weight*f(Transformed Conversion Rate SD)). This equation uses some of the listed factors 301. In alternate embodiments, fewer or more of the factors 301 may be used to calculate the publisher score. The f(x) is a function such as that from the transformer 324. The function transforms the standard deviation from the mean (SD) from the deviator 326 for each of the factors in the equation. A weight corresponding to each of the factors is multiplied by the transformed value with the weightor 328. As shown in the equation, the only factor that is not multiplied by a weight is the size of the publisher. The “Transformed Conversion Rate SD” is a variable in the first term of “RPM weight*f(Transformed RPM SD, Transformed Conversion Rate SD)” The “Transformed Conversion Rate SD” indicates that the transformation function for RPM incorporates the conversion rate SD. The RPM score may be adjusted downwards based on the following formula. If the RPM standard deviation is greater than X and conversion rate standard deviation is less than X, then the RPM score may decrease by Factor×RPM SD×CVR SD×% Clicks Covered.

FIG. 6 illustrates an exemplary published page 600 having advertisements displayed thereon. The page 600 is displayed by a publisher and may be a web page displayed on the Internet. The page 600 includes content 602, which is generally the purpose of the page. The content 602 may be evaluated as described above. Objectionable content 602 may result in a warning, suspension, or termination, which affects the publisher's score. The page 600 is shown with slots for four advertisements. There are two top ad slots 604, 606 and two side ad slots 608, 610. In this embodiment, the advertisement provider may supply the advertisements to supply those four slots. The advertisements that are provided may be through Content Match® which selects advertisements based on the content 602 of the page 600.

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 704 includes a cache or random access memory for the processor 702. In alternative embodiments, the memory 704 is separate from the processor 702, such as a cache memory of a processor, the system memory, or other memory. The memory 704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 704 is operable to store instructions executable by the processor 702. The functions, acts or tasks illustrated in the figures or described herein may be performed by the programmed processor 702 executing the instructions stored in the memory 704. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 700 may further include a display unit 714, such as a liquid crystal display (LCD), an organic light emitting diode (OLED), a flat panel display, a solid state display, a cathode ray tube (CRT), a projector, a printer or other now known or later developed display device for outputting determined information. The display 714 may act as an interface for the user to see the functioning of the processor 702, or specifically as an interface with the software stored in the memory 704 or in the drive unit 706.

Additionally, the computer system 700 may include an input device 716 configured to allow a user to interact with any of the components of system 700. The input device 716 may be a number pad, a keyboard, or a cursor control device, such as a mouse, or a joystick, touch screen display, remote control or any other device operative to interact with the system 700.

In a particular embodiment, as depicted in FIG. 7, the computer system 700 may also include a disk or optical drive unit 706. The disk drive unit 706 may include a computer-readable medium 710 in which one or more sets of instructions 712, e.g. software, can be embedded. Further, the instructions 712 may embody one or more of the methods or logic as described herein. In a particular embodiment, the instructions 712 may reside completely, or at least partially, within the memory 704 and/or within the processor 702 during execution by the computer system 700. The memory 704 and the processor 702 also may include computer-readable media as discussed above.

The present disclosure contemplates a computer-readable medium that includes instructions 712 or receives and executes instructions 712 responsive to a propagated signal, so that a device connected to a network 720 can communicate voice, video, audio, images or any other data over the network 720. Further, the instructions 712 may be transmitted or received over the network 720 via a communication port 718. The communication port 718 may be a part of the processor 702 or may be a separate component. The communication port 718 may be created in software or may be a physical connection in hardware. The communication port 718 is configured to connect with a network 720, external media, the display 714, or any other components in system 700, or combinations thereof. The connection with the network 720 may be a physical connection, such as a wired Ethernet connection or may be established wirelessly as discussed below. Likewise, the additional connections with other components of the system 700 may be physical connections or may be established wirelessly.

The network 720 may include wired networks, wireless networks, or combinations thereof. The wireless network may be a cellular telephone network, an 802.11, 802.16, 802.20, or WiMax network. Further, the network 720 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method of measuring quality of a publisher comprising:
receiving publisher data related to advertisements, wherein the publisher data comprises a conversion variable, an impressions variable, and a traffic quality variable; and
calculating a publisher score based on the publisher data.

2. The method according to claim 1 wherein the step of calculating a publisher score based on the publisher data comprises:
normalizing the data for each of the variables;
determining a standard deviation from the mean for each of the normalized variables;
transforming the normalized standard deviation from the mean for each of the variables;
multiplying each of the transformed variables by a weight associated with the variable; and
combining each of the weighted, transformed variables to calculate the publisher score.

3. The method according to claim 1 wherein the publisher data is related to a display of at least one advertisement on a page.

4. The method according to claim 3 wherein the page is a web page configured to be displayed on a web browser.

5. The method according to claim 1 wherein the impressions variable comprises at least one of a percent of domestic clicks, revenue per thousand (RPM), price per click (PPC) or combinations thereof.

6. The method according to claim 5 wherein the publisher data further comprises a size variable.

7. The method according to claim 6 wherein the publisher data further comprises a publisher review warnings variable, suspensions variable and terminations variable.

8. The method according to claim 6 wherein the publisher score based on the publisher data is calculated by a formula Publisher Score=f(Transformed Size SD) * (RPM weight * f(Transformed RPM SD, Transformed Conversion Rate SD)+PPC weight * f(Transformed PPC SD)+% Domestic Clicks weight * f(Transformed % Domestic Clicks SD)+Traffic Quality Score weight * f(Transformed Traffic Quality Score SD)+Volatility weight * f(Transformed Volatility SD)+Conversion Rate weight * f(Transformed Conversion Rate SD)), wherein SD is standard deviation and the function f(x) is a normalization.

9. A system calculating a publisher score comprising:
a publisher network server configured to be connected with a network and to receive the publisher data factors from publishers; and
an evaluator coupled with the publisher network server to receive publisher data factors, wherein the evaluator comprises:
a deviator for calculating the standard deviation from the mean of each of the factors;
a transformer, coupled with the deviator, for applying a function to the standard deviations from the mean for each of the factors; and
a weightor, coupled with the transformer, for applying a weight to each of the transformed standard deviations from the mean for each of the factors;
wherein the publisher score is based on the weighted transformed standard deviations for each of the factors.

10. The system according to claim 9 wherein the at least one publisher data factor comprises at least one of a conversion rate, a traffic quality, a domestic click percentage, a revenue per thousand (RPM), a volatility, or combinations thereof.

11. The system according to claim 10 wherein the at least one publisher data factor further comprises at least one of a publisher review warning, a publisher review suspension, a publisher review termination, or combinations thereof.

12. The system according to claim 9 wherein the publishers display a page, wherein the page displays at least one advertisement.

13. (canceled)

14. The system according to claim 9 further comprising a publisher network database coupled with the publisher network server and configured to store the publisher data related to the publishers.

15. The system according to claim 9 wherein the evaluator comprises a processor, wherein the processor includes the deviator, the transformer and the weightor.

16. The system according to claim 9 wherein the weight applied to each of the transformed standard deviations for each of the at least one publisher data factors reflects the relative importance of the at least one publisher data factor.

17. The system according to claim 9 wherein the weightor is configured to multiply the publisher score by a size of the publisher, wherein a larger publisher has a higher multiplier.

18. In a computer readable storage medium having stored therein data representing instructions executable by a programmed processor for determining a publisher score, the storage medium comprising instructions operative to:
gathering advertising data associated with the publisher, wherein the advertising data comprises factors including a conversion rate, a domestic click percentage, a traffic quality score, or combinations thereof, the factors associated with the publisher; combining the factors for the publisher into a publisher raw score; and generating the publisher score from the publisher raw score.

19. The storage medium according to claim 18 wherein the step of combining the factors further comprises:
determining a standard deviation for each factor;
transforming the standard deviation for each factor based on a predetermined function;
multiplying the transformed standard deviation for each factor by a weight associated with each factor to generate a raw score for each factor; and
combining the raw scores for each factor into the publisher raw score.

20. The storage medium according to claim 18 wherein the factors further comprise at least one of a conversion rate, a traffic quality, a domestic click percentage, a revenue per thousand (RPM), a volatility, or combinations thereof.

21. The storage medium according to claim 20 wherein the factors further comprise at least one of a publisher review warning, a publisher review suspension, a publisher review termination, or combinations thereof.

22. The storage medium according to claim 18 wherein the publisher displays a page, wherein the page displays at least one advertisement, further wherein the advertiser data is based on the at least one advertisement.

23. (canceled)

24. A method of measuring and scoring a plurality of publishers comprising:
receiving publisher data related to advertisements for each of the plurality of publishers;
calculating a publisher score based on the publisher data for each of the plurality of publishers;
comparing the publisher score for each of the plurality of publishers with one another; and
assigning a higher quality value to a publisher with a higher publisher score relative to other publishers from the plurality of publishers.

25. (canceled)

26. The method of claim 24 wherein the quality value is an indication of a likelihood of success of an advertisement with a particular publisher or an indication of desirability for advertisers to place an advertisement with a particular publisher.

27. The method of claim 26 wherein the likelihood of success of the advertisement includes an expected conversion rate of the advertisement.

28. The method of claim 24 wherein the publisher data comprises at least one of a conversion, an impression, a traffic quality, percent of domestic clicks, revenue per thousand (RPM), price per click (PPC), a publisher review warnings variable, a suspensions variable, a terminations variable, or combinations thereof.
